(19) United States
(12) Patent Application Publication
(10) Pub. No.: US 2009/0268982 A1
(43) Pub. Date: Oct. 29, 2009

(54) IMAGE PROCESSING APPARATUS AND CONTROL METHOD THEREOF

(75) Inventor: Hiroyuki Sakai, Chigasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/424,968

(22) Filed: Apr. 16, 2009

(30) Foreign Application Priority Data
Apr. 24, 2008 (JP) 2008-114416

(51) Int. Cl. G06K 9/40

(52) U.S. Cl. 382/275; 382/312

(57) ABSTRACT

Provided herein is an image processing apparatus comprising a scanner that reads an image, in which a plurality of blocks each having a feature value are embedded, and outputs image data of the image, a block position detector that detects a position of each block, which is embedded in the image data outputted by the scanner, a block misalignment calculator that calculates a misalignment value of the position of each block based on the detected position of each block and a specification of each block which has been set in advance, and a block misalignment corrector that corrects the image data based on the misalignment value.

### BACKGROUND OF THE INVENTION

1. Field of the Invention

The present invention relates to an image processing apparatus and a control method thereof for reading an image, in which a plurality of blocks are embedded, and correcting distortion of the read image.

2. Description of the Related Art

Recently, an increasing number of apparatuses capable of image sensing or image reading, for example, copying machines, scanners, digital cameras, mobile telephones with camera, have been provided, and demands for printing image data obtained by these apparatuses have also been increasing. Due to improved image-reading performance, there are many occasions in which image data read by such apparatus is printed and the printed image is read again by an image reading apparatus. Furthermore, high fidelity, where a printed image is identical to a read image, has been required.

The performances of conventional image reading apparatuses largely depend upon the performance of image sensors. Depending on the image sensor's performance, problems arise in that a read image is distorted, expanded, or contracted. For an image sensor, a CCD image sensor, a CMOS image sensor or the like is used for reading an image as optical data and converting the optical data into image data.

Japanese Patent Laid-Open No. 2002-171395 (D1) discloses a technique for solving such problem of dependence on the image sensor's performance. According to D1, image data (partial image) included in a region (a region having a predetermined size at a predetermined position in an original image), which is assumed to be a partial area, is extracted from the image data of an original document. Next, fast Fourier transformation is performed on the image data which is assumed to be a partial image (semi-partial image), and based on obtained frequency data, a peak point is acquired and stored. Next, phase component data of each peak point included in the semi-partial image is obtained and stored, then “distortion” between the peak point position data and ideal peak point position data is corrected. Next, distortion between the first pixel of the semi-partial image and the first pixel of the partial image is detected, and digital watermark data is read from image data of the original document.

According to the foregoing conventional technique, it is possible to perform correction by extracting a partial image from the image data of the original document and obtaining a gradient and enlargement/reduction with respect to the entire image data; however, it is difficult to correct local distortion. For instance, in general scanners, CCD sensor elements are horizontally arranged in line and the arranged image sensor elements or an original document is vertically moved line by line for reading the original document. Herein, assume that the direction the CCD sensor elements are arranged is the main scanning direction, and the direction the CCD or the original document moves is the sub-scanning direction. When an original document is read by a scanner in the above-described manner, distortion in the main scanning direction is generated because of the CCD performance, or distortion in the sub-scanning direction is generated because of the performance of the mechanical part moving the CCD or the original document. Therefore, horizontal distortion in the main scanning direction combined with vertical distortion in the sub-scanning direction generates local distortion in image data of the original document read by the image reading apparatus. It has been difficult for the above-described conventional technique to correct such local distortion.

### SUMMARY OF THE INVENTION

An aspect of the present invention is to eliminate the above-mentioned problems with the conventional technology.

According to an aspect of the present invention, it is possible to provide an image processing apparatus and a control method thereof which can correct distortion in image data of a read original document.

According to an aspect of the present invention, there is provided an image processing apparatus for reading an image and outputting image data in which distortion of the image is corrected, comprising: an image reader configured to read an image, in which a plurality of blocks each having a feature value are embedded, and output image data of the image; a block position detector configured to detect a position of each block, which is embedded in the image data outputted by the image reader; a block misalignment calculator configured to calculate a misalignment value of the position of each block, which is detected by the block position detector, based on the position of the each block detected by the block position detector and a specification of the each block which has been set in advance; and a corrector configured to correct the image data, which is outputted by the image reader, based on the misalignment value calculated by the block misalignment calculator.

Further features and aspects of the present invention will become apparent from the following description of exemplary embodiments, with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram describing a functional configuration of an image processing system according to an exemplary first embodiment of the present invention;

FIG. 2 is a block diagram describing a configuration of an image processing system according to an exemplary embodiment of the present invention;

FIG. 3 is a flowchart describing an operational sequence in the image processing system according to the first embodiment of the present invention;

FIG. 4 depicts an explanatory view illustrating an example of a printed image read by a scanner according to the first embodiment;

FIG. 5 is a block diagram describing a functional configuration of a block position detector according to the first embodiment;

FIG. 6 depicts an explanatory view of the control performed in a partial block position detector according to the first embodiment;

FIG. 7 is a flowchart describing an operational sequence in the block position detector according to the first embodiment;

FIG. 8 depicts a view illustrating an example in which a plurality of block detection areas are set in image information which is outputted by a scanner according to the first embodiment;

FIG. 9 is a flowchart describing a sequence of partial block position detection control in step S12 of FIG. 7;

FIG. 10 depicts a view illustrating an example of a state in which a detected area identified in additional information separation control performed on the detection area in FIG. 8 does not coincide with the position of the embedded block (indicated by dotted lines);

FIG. 11 depicts a view illustrating an example of a state in which a detected area identified in additional information separation control performed on the detection area in FIG. 8 coincides with the position of the embedded block (indicated by dotted lines);

FIG. 12 depicts a view illustrating a list of code determination values of a detection area, shown as an example, which is calculated while shifting a position pixel by pixel in the detection area;

FIG. 13 depicts an overview of a graph in which code determination values in FIG. 12 are added respectively in the X-axis direction and Y-axis direction;

FIG. 14 depicts a view illustrating an example of a relation between image information and block position data inputted in the block position calculator;

FIG. 15 depicts a view illustrating block positions calculated based on the block positions of image information 111 shown in FIG. 14;

FIG. 16 is a flowchart describing a sequence of a block misalignment detection method executed by a block misalignment detector according to the first embodiment;

FIG. 17A depicts a view illustrating an example of block positions based on image information obtained by an image reading apparatus according to the first embodiment;

FIG. 17B depicts a view illustrating ideal block positions of image information obtained by the image reading apparatus according to the first embodiment;

FIGS. 18A and 18B depict explanatory views of the position of a selected block B11 and the position of a post-correction block C11 of the selected block B11;

FIGS. 19A and 19B depict explanatory views of the position of a second selected block B12 and the position of a post-correction block C12 of the selected block B12;

FIG. 20 is a flowchart describing an operational sequence of block misalignment correction control performed by a block misalignment corrector according to the first embodiment;

FIGS. 21A and 21B depict explanatory views illustrating a relation between block positions read by a scanner and ideal block positions according to the second embodiment; and

FIGS. 22A and 22B depict explanatory views illustrating a position of a selected block and a position of the block that has been corrected.

### DESCRIPTION OF THE EMBODIMENTS

Embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

In the present embodiment, descriptions are provided on an image processing system as an example which comprises an image reading apparatus for reading an original document, where a plurality of blocks respectively having different feature values are embedded.

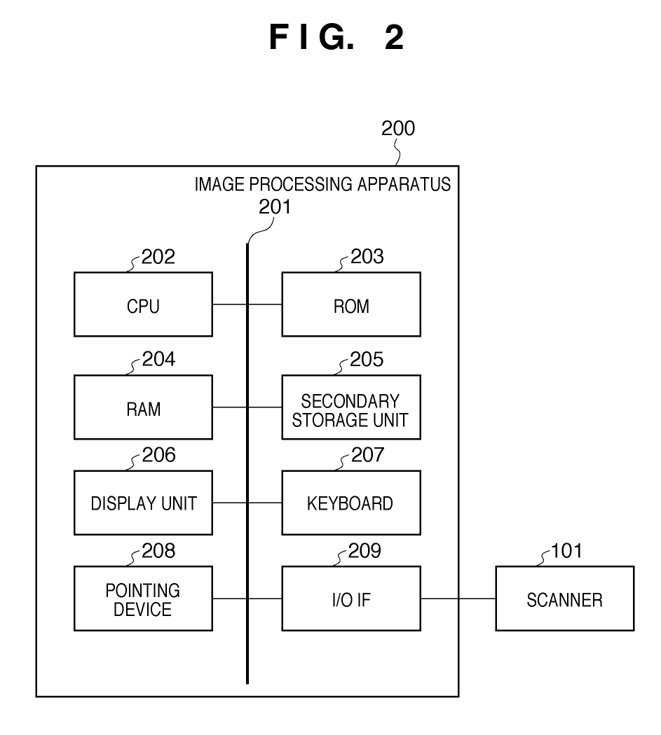

FIG. 2 is a block diagram describing a configuration of the image processing system according to the embodiment of the present invention.

The image processing system comprises an image processing apparatus 200 and a scanner 101 connected to the apparatus 200. In the image processing apparatus 200, a CPU 202, ROM 203, RAM 204, and a secondary storage unit 205, for example, a hard disk, are connected to a system bus 201. For a user interface, a display unit 206, a keyboard 207, and a pointing device 208 are connected to the CPU 202 or the like. Furthermore, the scanner 101 for image reading is connected to the image processing apparatus 200 via an I/O interface 209.

When execution of an application program (having a function for executing the control which will be described below) is designated, the CPU 202 reads a corresponding program, which has been installed in the secondary storage unit 205, and loads it to the RAM 204. Thereafter, the CPU 202 launches the program to execute the designated control.

### First Embodiment

Hereinafter, the image processing system according to the first embodiment of the present invention is briefly described with reference to the drawings.

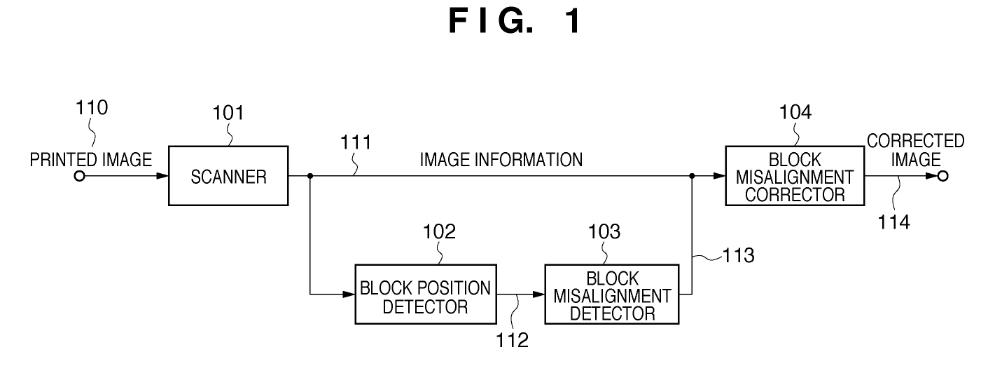

FIG. 1 is a block diagram describing a functional configuration of the image processing system according to the first embodiment.

The image processing system comprises a scanner 101 which reads a printed image 110 and outputs image information of the printed image, a block position detector 102 which performs processing on the image information 111 outputted by the scanner 101, a block misalignment detector 103, and a block misalignment corrector 104.

The scanner 101 performs mechanical scanning, converts position information and color information of the pixels included in an input-target original document (e.g., photographs, texts, drawings, three-dimensional objects) into digital data, and outputs the converted data as image information 111. Assume that, in the present embodiment, the input-target original document is printed paper (printed image 110) on which an image is printed. The image includes a block in which additional information is embedded. Also assume that the image information 111 outputted by the scanner 101 is data which consists of three types of colors, for example, red, green, and blue, and that the image information 111 has 24 bits for one pixel, each color having 8 bits.

The block position detector 102 performs, in block units, analysis of a texture's frequency feature on the image information 111, which is output by the scanner 101, in order to detect a multiplexed pattern embedded in block units. Based on the frequency feature value, the block position detector 102 detects positions of a plurality of blocks embedded in the printed image 110, and outputs block position data 112 indicative of the position of each block. Assume that, in the present embodiment, position data of each block is expressed by position coordinates of the upper left corner of the block. The block misalignment detector 103 detects block misalignment by comparing the block regularity (specification that defines the block size, shape, arrangement and the like), which has been set in advance, with the block position data 112 detected by the block position detector 102. The block regularity according to the first embodiment assumes that the block is, for instance, a square or a rectangle. In accordance with the block regularity, an ideal block position is obtained. The pre-correction block position detected by the block position detector 102 and the post-correction block position are outputted as the misalignment correction data 113. Based on the block position detected by the block position detector 102 and the ideal block position, the block misalignment corrector 104 corrects the image information 111 read by the scanner 101. More specifically, since the distorted block position read by the scanner 101 and the ideal block position have been acquired, the image information including the distorted block positions is converted to image information constructed by blocks of ideal block positions, and the converted image information is output as the corrected image 114.

According to the block regularity of the first embodiment, each block is a square block having N×N pixels. However, as long as it is possible to perform block position detection and block misalignment calculation on the embedded block, the block may have any shape. For instance, the predetermined block regularity may be embedded in the additional information which is embedded in each block, and the additional information embedded in the block may be restored by restoration processing so that the additional information can be used in block misalignment detection.

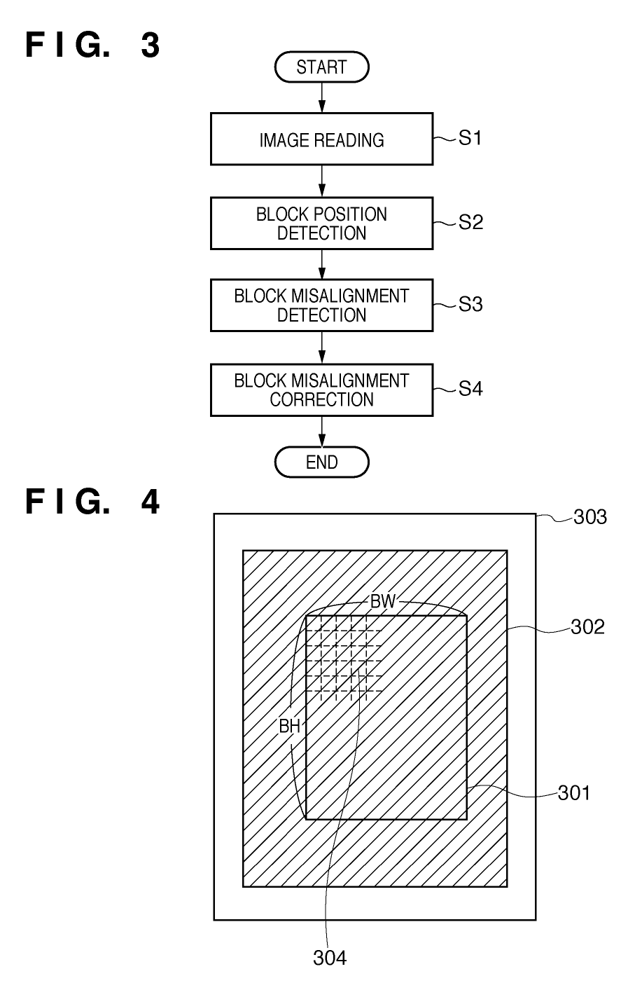

FIG. 3 is a flowchart describing an operational sequence in the image processing system according to the first embodiment of the present invention.

In step S1, the printed image 110, in which additional information is embedded in block units, is read by the scanner 101 and outputted as read image information 111. In step S2, the block position detector 102 inputs the image information 111 and detects the position of each block in which additional information is embedded. The detected block position data 112 is outputted to the block misalignment detector 103. In step S3, the block misalignment detector 103 detects in block units a position misalignment in the block position data 112, and outputs the misalignment correction data 113. In step S4, the block misalignment corrector 104 inputs the image information 111 and the misalignment correction data 113, corrects the image information 111 based on the misalignment correction data 113, and outputs the corrected result as the corrected image 114.

Note, although the image reading apparatus according to the first embodiment employs a scanner 101 as a reading method of the printed image 110, the present invention is not limited to this. As long as the apparatus can read an image with image quality (resolution) sufficient to allow the additional information embedded in the printed image 110 to be extracted, a digital camera, a mobile telephone with camera, a film scanner or the like may be employed.

FIG. 4 depicts an explanatory view illustrating an example of a printed image read by the scanner 101 according to the first embodiment.

The print medium (original document) 302, which corresponds to the printed image 110 in FIG. 1, includes an additional information embedding area 301. By optically reading the print medium 302 in the range represented by the scanner reading range 303, the image information 111 can be obtained. The reading range 303 of the scanner 101 is set larger than the size of the print medium 302. The additional information embedding area 301 is an area where a plurality of blocks 304 having additional information are embedded. Assuming that each block 304 is a square block having N×N pixels, the embedded area 301 is defined as an area having a width (BW) and a height (BH). The block position detector 102 inputs the image information 111 which is outputted by the scanner 101, and detects positions of the blocks in which additional information is divided and embedded in block units.

To detect a block position using the block position detector 102, a feature value analysis is first performed on the image information 111 outputted by the scanner 101, while the position is shifted pixel by pixel or plural pixels by plural pixels. In the feature value analysis, in accordance with a predetermined size of the block 304 which is the above-described regularity, analysis of the texture's frequency feature is performed in units of the block size. Based on the texture's frequency feature as well as the frequency feature value which is calculated by the frequency feature analysis processing, a code determination value which serves as a determination reference for determining a code embedded in the block is calculated. Therefore, the code determination value is a determination value which serves as a block position determination reference. Next, block positions are detected based on the frequency feature value and the code determination value. Details of the block position detector 102 will be described below.

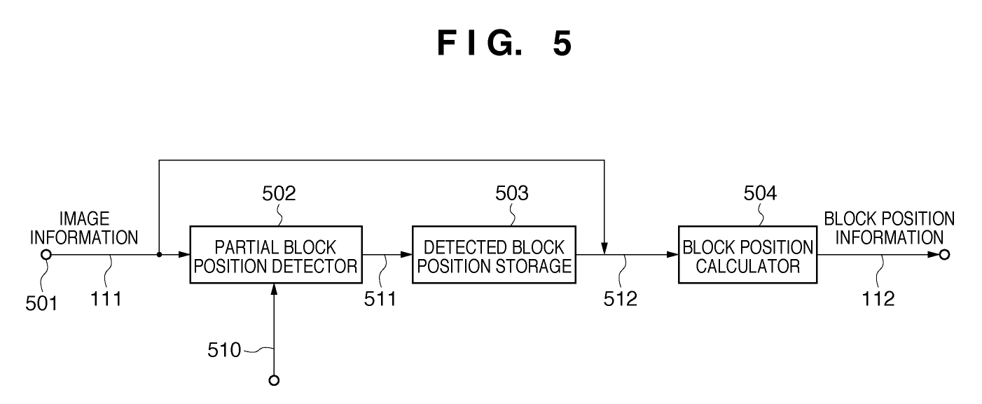

FIG. 5 is a block diagram describing a functional configuration of the block position detector 102 according to the first embodiment.

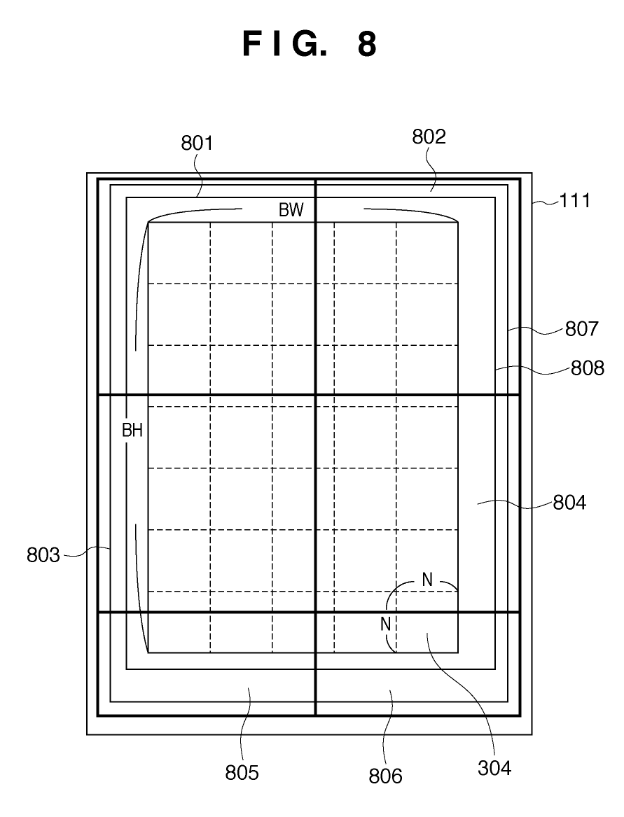

The block position detector 102 comprises an input terminal 501, a partial block position detector 502, a detected block position storage 503, and a block position calculator 504. The image information 111 inputted through the input terminal 501 is provided to the partial block position detector 502 and the block position calculator 504. Meanwhile, area information 510, which corresponds to the above-described additional information embedding area 301, is inputted to the partial block position detector 502. The partial block position detector 502 detects a block position within the designated area of the area information 510, and outputs block position information 511 to the detected block position storage 503. Note that, as will be described later with reference to FIG. 8, the first embodiment assumes a case where a plurality of area information 510 are inputted for the image information 111.

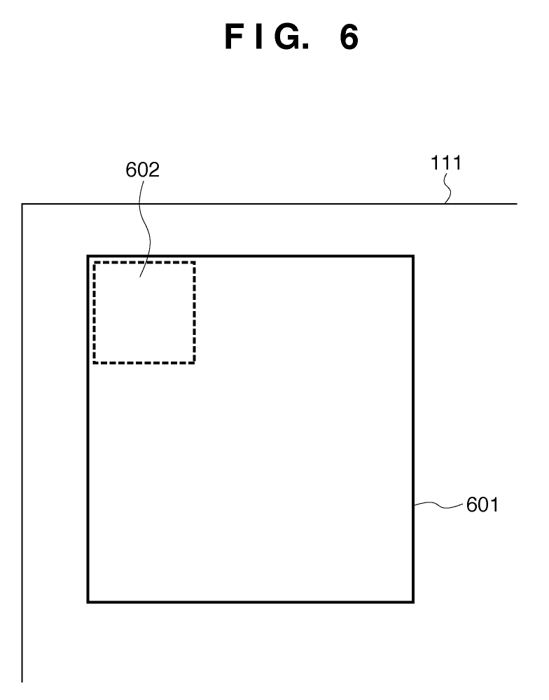

FIG. 6 depicts an explanatory view of the control performed in the partial block position detector 502.

Assume that the area information 510 indicates a detection area 601 in the image information 111. In this stage, the block position detector 102 detects block positions in the detection area 601. To detect a block position, the texture's frequency is analyzed in the image information for additional information separation, while the position of the block 602 is shifted pixel by pixel in the detection area 601. Then, a frequency feature value in the frequency analysis and a code determination value in the additional information separation are calculated. Next, feature extraction is performed based on the frequency feature value and the code determination value, and the block positions are detected. Note that the frequency feature value and the code determination value calculated herein will differ depending on whether the calculation is performed at a block position in which additional information is embedded or the calculation is performed at a block position in which additional information is not embedded. Also, the determination value will differ depending on whether the calculation is performed at a block position where additional information is embedded or the calculation is performed at a distorted block position where additional information is embedded.

The detected block position storage 503 inputs the position information 511 of each block, which has been detected by the partial block position detector 502, and stores it in the memory (RAM 204). Next, it is determined whether or not the processing in the area, which is designated by the area information 510, is completed. If the processing in the area has not been completed, block position detection is performed again by the partial block position detector 502, and the detected block position storage 503 stores the position information 511 in the memory. If the processing in the area has been completed, one or plural block position information 511 stored in the memory are outputted to the block position calculator 504 as position information 512. Based on the position information 512, the block position calculator 504 calculates the block position in which additional information is embedded, and outputs block position data 112.

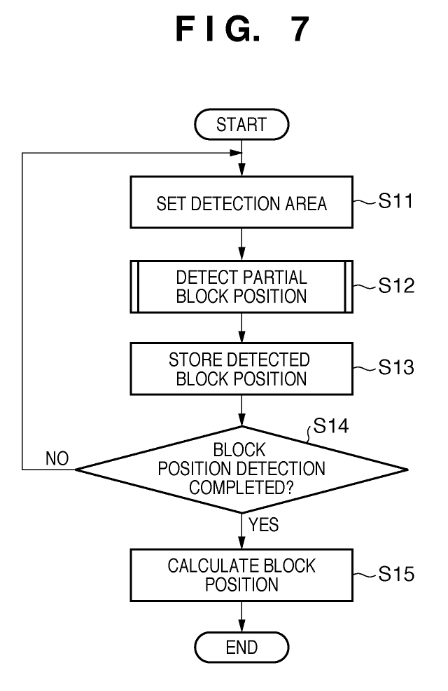

FIG. 7 is a flowchart describing an operational sequence in the block position detector 102 according to the first embodiment.

In step S11, the partial block position detector 502 sets a block detection area based on the area information 510. In step S12, partial block position detection is performed in the block detection area.

FIG. 8 depicts an example in which a plurality of block detection areas are set in the image information 111 which is outputted by the scanner 101 according to the first embodiment.

The block position detection area is represented by areas 801 to 806 indicated with heavy lines in the image information 111. Herein, six areas 801 to 806 are set in advance in the image information 111. Numeral 304 denotes the above-described block shown in FIG. 4. In FIG. 8, numeral 807 denotes an original document (printed image), and numeral 808 denotes an image area in which blocks are embedded in the original document.

Although a plurality of detection areas are set in advance in FIG. 8, the size, positions, and number of detection areas are not specifically limited. Furthermore, a detection area may be set in advance before the image information 111 is inputted. Alternatively, a detection area may be set in accordance with the image information 111, or position information 511 of the block which has been detected once may be used to set the next detection area. How the detection area is set is not specifically limited. For instance, based on the area information 510, the area of the image information 111 may be divided into four areas, and the four areas may be set as detection areas. Alternatively, space for detecting a block position may be set in advance in the area information 510, and a detection area may be set in accordance with the space predetermined in the area information 510 indicative of the next detection area.

In the partial block position detection control in step S12 in FIG. 7, block position detection is performed in the detection areas which have been set in step S11.

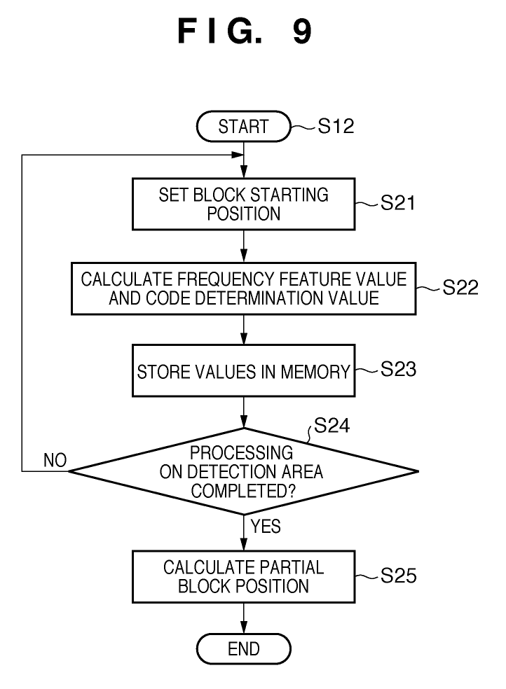

FIG. 9 is a flowchart describing a sequence of the partial block position detection control in step S12 of FIG. 7.

In step S21, a starting position of the block, which serves as a reference for additional information separation, is set. In step S22, starting from the block starting position, a texture frequency analysis is performed on the image in block units based on the block regularity, thereby calculating a frequency feature value. Based on the frequency feature value, a code determination value for performing code determination in units of embedded block is calculated. In step S23, the frequency feature value and the code determination value are stored in the memory (RAM 204). In step S24, it is determined whether or not the processing on the set detection area has been completed. If it has not been completed, the control returns to step S21; whereas if it has been completed, the control proceeds to step S25. In step S25, the block position in the detection area is calculated based on the frequency feature value and the code determination value for additional information separation, which have been obtained in step S22. The calculated block position is outputted as the block position information 511 to the detected block position storage 503.

A detailed description of the partial block position detection control is provided on the following example.

The description is provided assuming that the detection area set in step S11 is a 10,000-pixel area, having 100×100 pixels in the horizontal and vertical directions.

In step S21, a block starting position is set. Herein, one pixel is selected from the 10,000 pixels of the detection area of image data, and the position of the selected pixel is set as the block starting position. In the additional information separation control in step S22, the texture frequency analysis is performed on the image data in block units, starting from the block starting position set in step S21. Then, code determination is performed in units of embedded block. Based on the frequency feature value, a code determination value for performing code determination in units of embedded block is calculated. The frequency feature value and the code determination value calculated in this manner will differ depending on whether the calculation is performed at a block position in which additional information is embedded or the calculation is performed at a position where the embedded block position is distorted.

FIG. 10 depicts a view illustrating an example of a state in which the area 1001 identified in the additional information separation control performed on the detection area 801 in FIG. 8 does not coincide with the position of the embedded block (indicated by small dotted lines).

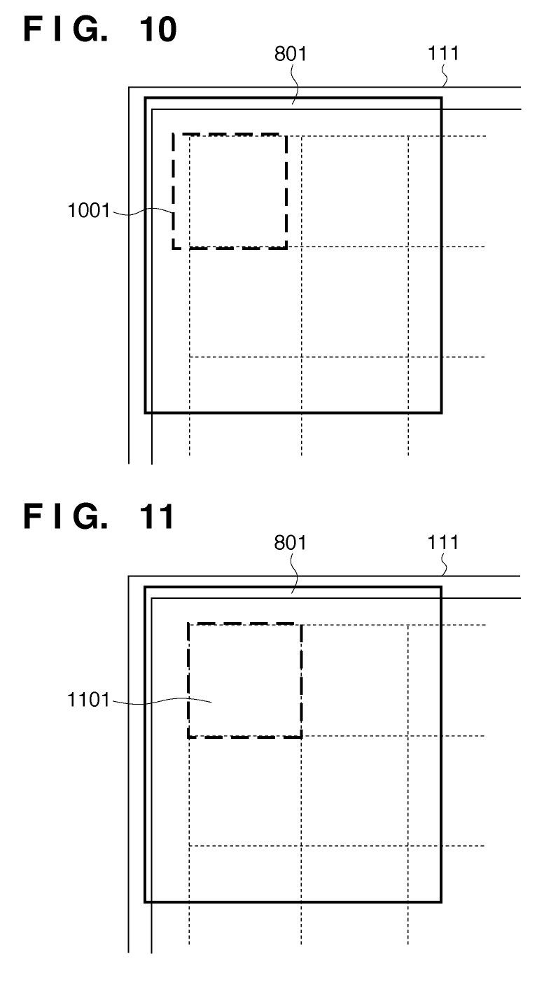

FIG. 11 depicts a view illustrating an example of a state in which the area 1101 identified in the additional information separation control performed on the detection area 801 in FIG. 8 coincides with the position of the embedded block (indicated by small dotted lines).

For instance, assuming a case where a determination value is obtained in FIGS. 10 and 11, a code determination value obtained in FIG. 10 becomes small, but a code determination value obtained in FIG. 11 becomes large.

In step S23 in FIG. 9, the frequency feature value and the code determination value which have been calculated in the additional information separation control in step S22 are stored in the memory (RAM 204). Note that although the frequency feature value and the code determination value are both stored in the memory in this embodiment, the present invention is not limited to this. For instance, only one of the frequency feature value and the code determination value may be stored in the memory.

In step S24, it is determined whether or not the processing on 10,000 pixels of the detection area has been completed. If it is determined in step S24 that the processing on the area has been completed, the control proceeds to the partial block position calculation control in step S25. Meanwhile, if it is determined that the processing on the area has not been completed, the control returns to step S21 to perform the block starting position setting control. Note that the completion determination in step S24 is made by, for instance, whether or not the calculation of the frequency feature value and the code determination value has been completed for 10,000 pixels. In the partial block position calculation control in step S25, the block position is calculated based on the code determination values for 10,000 pixels, which have been stored in the memory.

For the partial block position calculation method, described next is a method of calculating a block position based on, for example, the code determination value. Assume there is regularity in that the larger the calculated code determination value, the higher the possibility of coinciding with the embedded block position. In this case, the block position can be detected by extracting a large value of the calculated code determination value. Therefore, detecting the largest code determination value can detect a more accurate block position. For another example of the partial block calculation method, it is also possible to assume the following case: the smaller the calculated code determination value, the higher the possibility of coinciding with the embedded block position.

FIG. 12 depicts a view describing a list of code determination values of a detection area, shown as an example, which is calculated while the position is shifted pixel by pixel in the detection area designated by the area information 510.

In the case of FIG. 12, since the code determination value “60” is the largest value, the position having the code determination value “60” is determined to be the partial block position. The drawing shows code determination values calculated while the position is shifted pixel by pixel in the detection area. Assuming that the upper left coordinates (X, Y)=(0, 0) of the detection area are the reference, coordinates (X, Y)=(3, 3) are determined to be the partial block position. Besides this method, code determination values calculated while the position is shifted pixel by pixel may be added respectively in the X-axis direction and Y-axis direction, and based on the added values, the largest value for each of the X axis and Y axis may be calculated.

FIG. 13 depicts an overview of a graph in which code determination values in FIG. 12 are added respectively in the X-axis and Y-axis directions.

Assuming that the size of the embedded block is 6×6 pixels in FIG. 13, it is possible to presume that the maximum value appears every 6 pixels in the X-axis and Y-axis directions. Therefore, it is necessary to be able to detect a position having a maximum code determination value every 6 pixels in the X-axis and Y-axis directions. The 12×12 numbers of code determination values 1301, which are surrounded by the heavy lines, indicate the code determination values calculated pixel by pixel in a case where the detection area has 12×12 pixels. In the case of the code determination values 1301 shown in FIG. 12, it is assumed that the addition value of the code determination values in the X-axis direction is a X-axis total value 1302, and the sum value of the code determination values in the Y-axis direction is a Y-axis total value 1303. The graph 1304 expresses the X-axis total values 1302 of the determination values. The graph 1305 expresses the Y-axis total values 1303 of the determination values. As is shown in the graphs 1304 and 1305, features of the calculated determination values appear in the X-axis and Y-axis total values of the determination values.

In FIG. 13, assuming that the upper left coordinates (X, Y)=(0, 0) in the detection area are the reference, the peak of the code determination value appears at 6-pixel intervals, starting from the coordinates (X, Y)=(3, 3). Therefore, it is possible to presume that these positions are the block positions where additional information is embedded.

The detected block position storage 503 performs the detected block position storage control in step S13 in FIG. 7 and the partial block position detection completion determination in step S14. In the storage control in step S13, the block position information 511 detected by the partial block position detector 502 is sequentially stored in the memory (RAM 204). For instance, in a case where six detection areas 801 to 806 are set as shown in FIG. 8, six block position information 511 detected in respective areas are secured in the memory.

In the detection completion determination control in step S14, the inputted area information 510 is compared with the block on which detection processing has been completed. In a case where a plurality of detection areas are set, it is determined whether or not the block position detection processing has been completed for the plural numbers of detection areas. For instance, in a case where six detection areas 801 to 806 are set by the area information 510 as shown in FIG. 8, it is determined whether or not position detection processing has been completed for the six areas. If the position detection has not been completed, the control returns to step S11. If the position detection has been completed, the plurality of items of block position information 511 secured in the memory are outputted as the block position information 512.

The block position calculator 504 performs block position calculation in step S15 in FIG. 7. In the block position calculation control, the block position data 112 of the entire image information 111 is calculated based on the block position information 512 outputted by the detected block position storage 503.

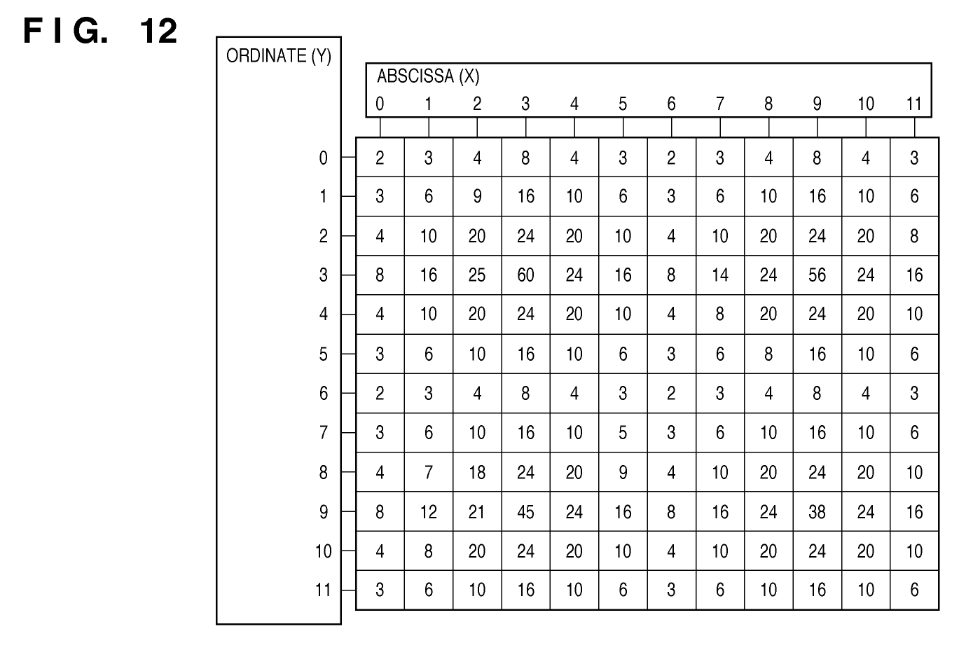

Next described with reference to FIGS. 14 and 15 is the block position calculation method which is performed by the block position calculator 504 according to the present embodiment.

FIG. 14 depicts a view illustrating an example of a relation between the image information 111 and the block position information 512 inputted in the block position calculator 504. Note that numeral 1403 denotes the size of an original document.

FIG. 15 depicts a view illustrating an example of block position data 112 calculated based on the block positions of the image information 111 shown in FIG. 14.

In FIG. 14, numerals 1401 and 1402 denote block positions indicated by the block position information 512 which has been detected in the detection area 1400 of the image information 111. To calculate the block position data 112 based on the positions 1401 and 1402, the well-known formulas for calculating a dividing point and an externally dividing point are employed, utilizing the square block size of N×N pixels set in advance.

Assume that the square block size of N×N pixels is 200×200 pixels, and coordinates of the position 1401 of the block position information 512 are (X, Y)=(300, 100). Also assume that coordinates of the position 1402 are (X, Y)=(704, 100). The interval between the X coordinate value of the position 1401 and the X coordinate value of the position 1402 is obtained (704−300=404). Since the square block size is 200×200 pixels, 404/200=2.02 is calculated. 2.02 is rounded off, thereby obtaining 2. By this calculation, it is possible to presume that there are two blocks in the space between the X coordinate value of the position 1401 and the X coordinate value of the position 1402. A dividing point of the positions 1401 and 1402 is calculated, and as a result, it is possible to presume that there is a block at the position (X, Y)=(502, 100). Also, an externally dividing point of the positions 1401 and 1402 is calculated, and as a result, it is possible to presume that there is a block at the position (X, Y)=(98, 100). The block position data 112 acquired in the above-described manner is all the position information of existing block positions in the image information 111, which have been obtained by executing interior division and exterior division based on the block position information 512.

In FIG. 15, the adjoining coordinate points of the block position data 112, which have been detected based on the position information in FIG. 14, are connected with dotted lines. Assume that one block surrounded by the dotted lines is the block in which N×N pixels are embedded. The grid point, where the dotted lines intersect, corresponds to the position of each block. The position information of each block is stored in the memory (RAM 204) of the detected block position storage 503. The position information of each block stored in the memory is, for instance, sequentially stored in the main scanning direction. If it becomes not to find a block position in the main scanning direction, the storage control is next shifted to the sub-scanning direction, then the block position information is sequentially stored in the main scanning direction. When the block position information of all blocks is stored in the memory in the foregoing manner, all items of the block position information stored in the memory, the number of blocks in the main scanning direction, and the number of blocks in the sub-scanning direction are outputted as block position data 112. The block position detector 102 detects block positions in the foregoing manner.

The block misalignment detector 103 inputs the block position data 112, which has been detected by the block position detector 102, and detects misalignment of each block. Then, information for correcting the detected misalignment of each block is outputted as misalignment correction data 113.

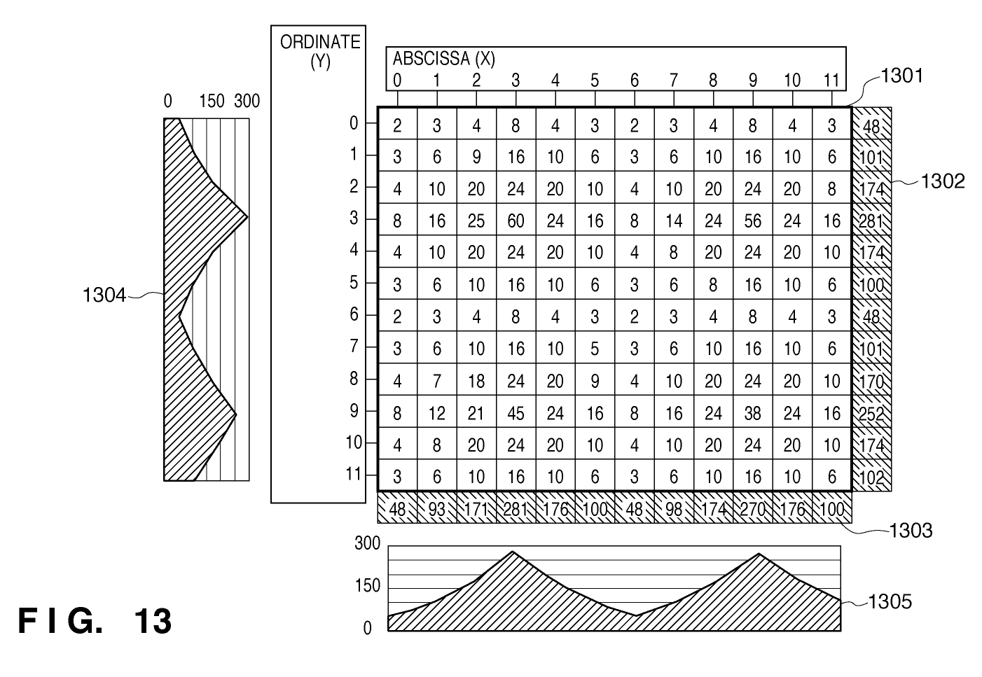

FIG. 16 is a flowchart describing a sequence of the block misalignment detection method executed by the block misalignment detector 103 according to the first embodiment.

In step S31, a block position is selected from the inputted block position data 112. Assume that a block position is selected in the same order as the block position embedding order in the block position data 112. In step S32, a block position, which is to be obtained after the block position is corrected, is calculated with respect to the block selected in step S31, taking the predetermined block regularity into consideration. In step S33, the pre-correction block position and the calculated post-correction block position are stored in the memory (RAM 204). In step S34, it is determined whether or not block misalignment has been calculated with respect to all items of the inputted block position data 112. If block misalignment has not been calculated with respect to all blocks, the control returns to step S31, the block position is moved to the next position, and steps S31 to S34 are repeated again. When steps S31 to S34 are to be performed again, the post-correction block position which has previously been calculated and stored in the memory is taken into consideration. When correction values are calculated with respect to all block positions, the control proceeds to step S35. In step S35, all the pre-correction block positions and the post-correction block positions stored in the memory are outputted as the misalignment correction data 113.

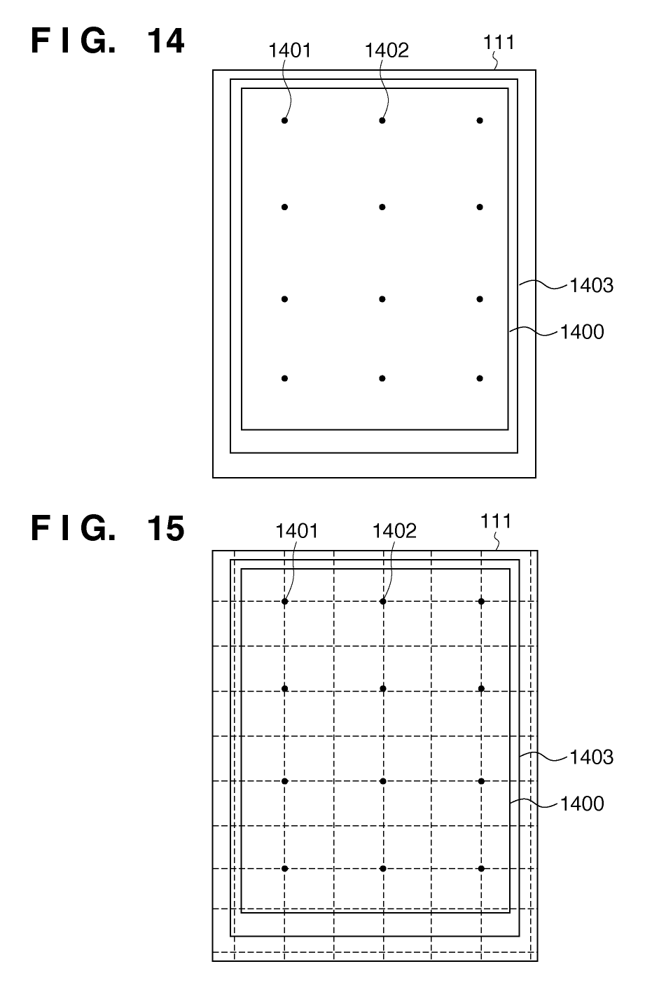

Next, described with reference to FIGS. 17 to 19, is a block misalignment detection method, using an example in which an image read by the image reading apparatus has a locally distorted width.

For the block regularity set in advance, assume that an embedded block is a square, and that the block size is 10×10 pixels in a case where an image is printed at a printing resolution of 600 dpi. The following description is provided assuming that the image information 111 used in block detection of the block position detector 102 is image data read at a reading resolution of 600 dpi.

FIGS. 17A and 17B depict explanatory views illustrating examples of ideal block positions and the block positions based on image information obtained by an image reading apparatus. FIG. 17A shows block positions based on image information obtained by the image reading apparatus, and FIG. 17B shows ideal block positions of the image information.

In FIG. 17A, reference numerals B11 to B14, B21 to B24, B31 to B34, B41 to B44, and B51 to B54 represent the blocks detected based on the image information obtained by the image reading apparatus. In FIG. 17B, reference numerals C11 to C14, C21 to C24, C31 to C34, C41 to C44, and C51 to C54 represent an ideal block arrangement. In other words, correction is performed in a manner such that FIG. 17A is corrected to FIG. 17B.

Comparing FIG. 17A with FIG. 17B, the blocks based on the image information which has been read by the image reading apparatus have locally narrower widths and locally wider widths than the widths of the ideal blocks. While the blocks based on the image information which has been obtained by the image reading apparatus have widths Wb1, Wb2, Wb3, and Wb4, the ideal blocks have widths Wc1, Wc2, Wc3, and Wc4. Wb2 has an equal width to Wc2, and Wb4 has an equal width to Wc4. Wb1 has a narrower width than Wc1, while Wb3 has a wider width than Wc3. Numeral 1701 denotes the position of the block detected at the farthest top left among the block position data 112 which has been detected by the block position detector 102. Herein, the coordinates of the position 1701 are defined (X, Y)=(0, 0).

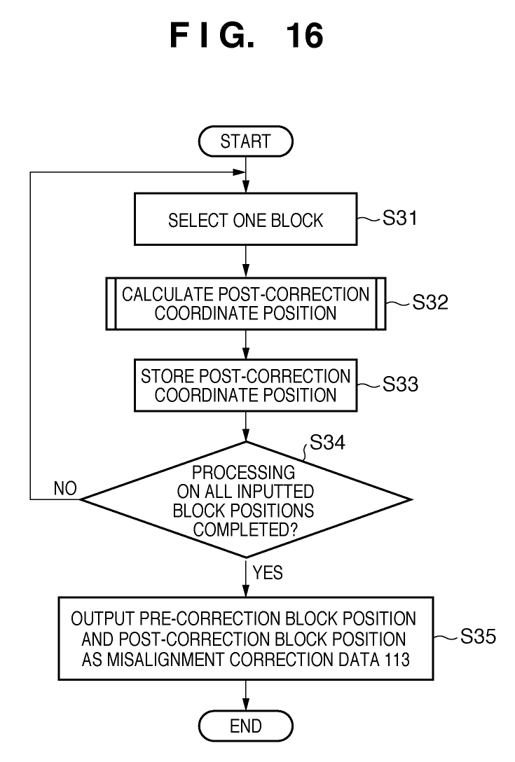

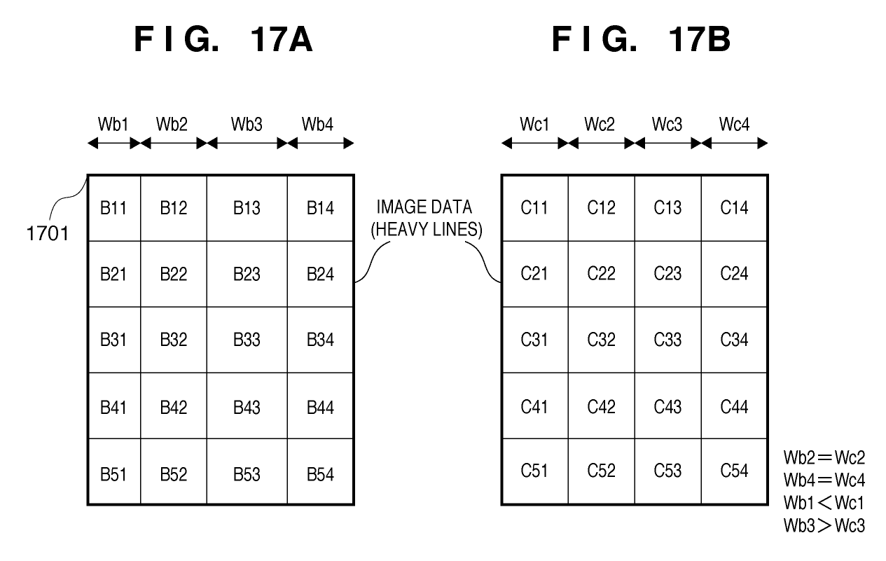

FIGS. 18A and 18B depict explanatory views illustrating examples of the position of the selected block B11 and the position of the post-correction block C11 of the selected block B11. In FIG. 18A, numerals 181 to 184 denote four vertices of the block B11. FIG. 18B, which shows the post-correction block C11, has four vertices 185, 186, 187, and 188 of the block C11 corresponding to the four vertices 181, 182, 183, and 184 of the block B11. In FIG. 18A, assume that the width of the block B11 is narrower by 2 pixels than the ideal block width.

The top left block (B11) in FIG. 17A is selected. The block B11 is shown in FIG. 18A, and the coordinates of the vertex 181 are (X, Y)=(0, 0). The following description is provided assuming that in FIG. 18A the width (W18a) is 8 pixels and the height (H18a) is 10 pixels. The space (width) between the vertices 181 and 182 as well as the space (width) between the vertices 183 and 184 are indicated by W18a, while the space (height) between the vertices 181 and 183 as well as the space (height) between the vertices 182 and 184 are indicated by (H18a). Therefore, the coordinates of the vertex 182 are (X, Y)=(8, 0). The coordinates of the vertex 183 are (X, Y)=(0, 10). The coordinates of the vertex 184 are (X, Y)=(8, 10).

Taking the coordinates (X, Y)=(0, 0) of the vertex 181 as a reference, coordinates of the post-correction block C11 are calculated in accordance with the block regularity. Herein the block regularity assumes that the block is a square and that the block size is 10×10 pixels. Therefore, the post-correction coordinates of the vertex 182 are obtained as (X, Y)=(10, 0). The post-correction coordinates of the vertex 183 are obtained as (X, Y)=(0, 10). The post-correction coordinates of the vertex 184 are obtained as (X, Y)=(10, 10). Therefore, the coordinates 185, 186, 187, and 188 of the block C11 in FIG. 18B are respectively (0, 0), (10, 0), (0, 10), and (10, 10). In other words, the width (W18b) and the height (H18b) of the block C11 in FIG. 18B are both 10. These positions of the pre-correction block and post-correction block are stored in the memory of the block misalignment detector 103. In the foregoing manner, a difference between the relative position of the pre-correction block and the block size according to the block regularity is detected as a block misalignment value.

Since the detection area shown in FIGS. 17A and 17B has 20 blocks, the block misalignment detector 103 performs block misalignment detection on positions of the 20 blocks. For a second block position, for instance, the block B12 located on the right side of the top left block in FIG. 17A is selected.

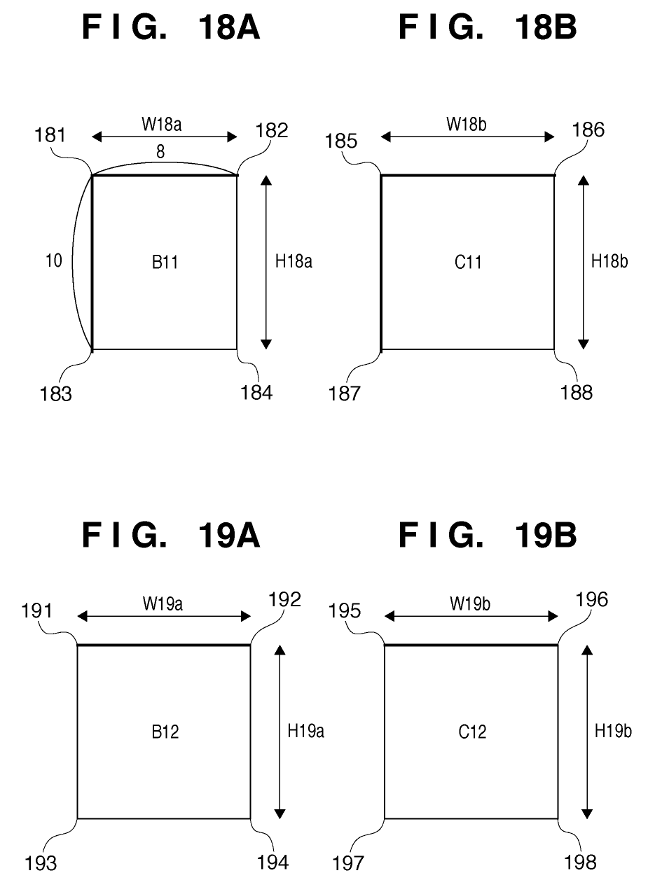

FIGS. 19A and 19B depict explanatory views illustrating examples of the position of the second selected block B12 and the position of the post-correction block C12 of the selected block B12.

FIG. 19A shows the selected block B12 having four vertices 191, 192, 193, and 194. FIG. 19B shows the corrected block C12 of the block B12, having four vertices 195, 196, 197, and 198. The following description is provided assuming that the selected block B12 is not distorted.

Since coordinates of the vertex 191 correspond to the coordinates of the vertex 182 in FIG. 18A, the coordinates of the vertex 191 are (X, Y)=(8, 0). Since the block B12 is not distorted, the coordinates of the vertices 192, 193, and 194 are respectively (X, Y)=(18, 0), (X, Y)=(8, 10), and (X, Y)=(18, 10).

Similar to the first block, the position of the post-correction block C12 is calculated in accordance with the block regularity. However, the post-correction block position corresponding to the coordinates of the vertex 191 is wrong, since it is found to be distorted in the misalignment detection of the block B11. Therefore, coordinates of the post-correction block C11, which have been stored in the memory, are read. Based on the read coordinates of the post-correction block C11, coordinates of the post-correction block C12 are calculated. The coordinates of the vertices 195 and 197 in FIG. 19B are the same coordinates as that of the vertices 186 and 188 in FIG. 18B. Therefore, the coordinates of the vertex 195 of the block C12 are (X, Y)=(10, 0), which are equal to the coordinates of the vertex 186. The coordinates of the vertex 197 are (X, Y)=(10, 10). Since the block B12 is not distorted, the coordinates of the vertex 196 are (X, Y)=(20, 0), and the coordinates of the vertex 198 are (X, Y)=(20, 10). The position of the post-correction block calculated in the foregoing manner is stored in the memory.

When data is stored in the memory, the post-correction block position is stored in the memory in the same order that the block position detector 102 has stored the block positions in the memory. For instance, block positions are sequentially stored in the main scanning direction. When there is no block to be detected in the main scanning direction, the detection is shifted to the sub-scanning direction, then block positions are sequentially stored again in the main scanning direction. When misalignment correction is completed with respect to all blocks included in the block position data 112, all the pre-correction block positions stored in the memory and the calculated post-correction block positions are outputted as misalignment correction data 113. Note, whether or not the processing on all blocks has been completed is determined by whether or not the number of blocks in the main scanning direction and sub-scanning direction which have been detected by the block position detector 102 has reached the detected number of all blocks.

In the foregoing manner, the block misalignment corrector 104 outputs the corrected image 114 (FIG. 1) which is obtained by performing correction on the image information 111 based on the misalignment correction data 113 provided from the block misalignment detector 103.

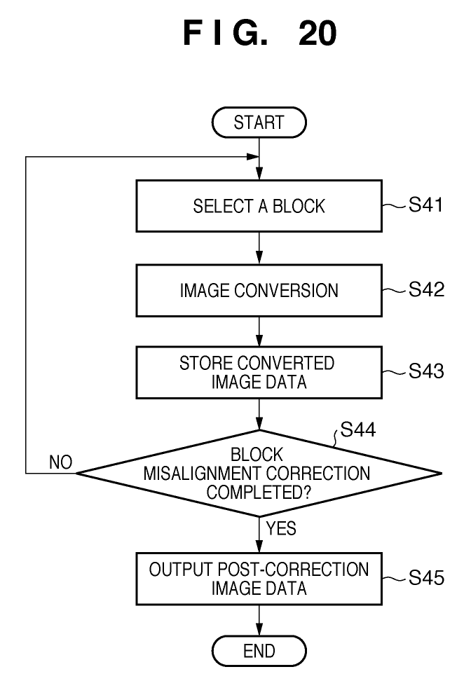

FIG. 20 is a flowchart describing an operational sequence of block misalignment correction control performed by the block misalignment corrector 104 according to the first embodiment.

In step S41, one block position is selected from the input misalignment correction data 113. Assume that a block position is selected in the same order as the block position embedding order in the block position data 112. In step S42, arbitrary conversion processing is performed on the image information 111 read by the scanner 101 based on the pre-correction and post-correction position information of the block selected in step S41. For the arbitrary conversion, for instance, enlargement is performed in a case where the post-correction image size is larger than the pre-correction image size, reduction is performed in a case where the image size is to be reduced, rotation is performed in a case where the image is tilted, or coordinate conversion is performed in a case where coordinates have been moved. The methods of conversion, for example, enlargement, reduction or the like, are not limited to specific methods as long as they are known methods, for example, nearest-neighbor interpolation, linear interpolation, affine transformation and so on.

In step S43, the converted image data of the selected block is stored in the memory (RAM 204). Upon storing the image data in the memory, the adjoining post-correction blocks are combined and stored in the memory. In this manner, post-correction image data of the entire image information 111 are ultimately stored in the memory. In step S44, it is determined whether or not block misalignment correction has been performed with respect to all the blocks included in the misalignment correction data 113. If all the blocks have not been subjected to block misalignment correction, the block is shifted for misalignment correction, and the control returns to step S41 for repeating the above-described control. When it is determined in step S44 that the block misalignment correction on all blocks has been completed, the control proceeds to step S45. All the image data which have been converted and stored in the memory are outputted as the corrected image 114, and this control ends.

Next, a block misalignment correction method is described with reference to FIGS. 17A, 17B, 18A, 18B, 19A and 19B. Similar to the case of the block misalignment detector 103, the following description is provided on a case where an image read by the image reading apparatus has a locally distorted width.

First, the top left block (B11) in FIG. 17A is selected. Similar to the above description provided with reference to the block misalignment detector 103, the selected block is shown in FIG. 18A.

FIGS. 18A and 18B show a block in which the block width is narrower by 2 pixels than the ideal block width, as similar to the aforementioned case described with reference to the block misalignment detector 103. Before block misalignment correction is performed, coordinates of the vertex 181 are (X, Y)=(0, 0); coordinates of the vertex 182 are (X, Y)=(8, 0); coordinates of the vertex 183 are (X, Y)=(0, 10); and coordinates of the vertex 184 are (X, Y)=(8, 10). Meanwhile in FIG. 18B on which position misalignment has been performed, coordinates of the vertex 185 are (X, Y)=(0, 0); coordinates of the vertex 186 are (X, Y)=(10, 0); coordinates of the vertex 187 are (X, Y)=(0, 10); and coordinates of the vertex 188 are (X, Y)=(10, 10).

Next, taking the coordinates (X, Y)=(0, 0) of the top left vertex 181 of the pre-correction block B11 in FIG. 18A as a reference, image data having a width and a height (8×10 pixels) is converted to image data having a post-correction width and a height (10×10 pixels). In the block conversion in FIGS. 18A and 18B, since the number of pixels of the post-correction block is larger than the number of pixels of the pre-correction block, enlargement is performed. For enlargement processing, any known methods, for example, nearest-neighbor interpolation, linear interpolation, may be used. The image data of the block C11, on which conversion has been performed on the selected block B11, is stored in the memory. The above-described processing is executed on other blocks.

Next, a description is provided with reference to FIGS. 19A and 19B on a case where the second selected block is not distorted, as similar to the aforementioned case described with reference to the block misalignment detector 103.

In FIGS. 19A and 19B, coordinates of the vertex 191 are (X, Y)=(8, 0); coordinates of the vertex 192 are (X, Y)=(18, 0); coordinates of the vertex 193 are (X, Y)=(8, 10); and coordinates of the vertex 194 are (X, Y)=(18, 10).

Taking the coordinates (X, Y)=(8, 0) of the top left vertex 191 of the pre-correction block B12 as a reference, image data having 10×10 pixels is converted to post-correction image data having 10×10 pixels. In the block conversion in FIGS. 19A and 19B, since the number of pixels does not change before and after the correction, no enlargement or reduction is performed. Since the coordinates of the post-correction image data of the first selected block are distorted, the block coordinate position of the first converted image data stored in the memory is taken as a reference. The coordinates of the vertices 195 and 197 in FIG. 19B are the same coordinates as that of the vertices 186 and 188 in FIG. 18B, which are the post-correction coordinate positions of the first and second selected blocks. Therefore, image data conversion of 10×10 pixels is performed using the coordinates (X, Y)=(8, 0) of the top left vertex 191 of the pre-correction block and the coordinates (X, Y)=(10, 0) of the top left vertex 195 of the block C12 as a reference. The block image data converted in the foregoing manner is stored in the memory. The data is stored in the memory in the same order that the block position detector 102 has stored the block positions in the memory. For instance, block positions are sequentially stored in the main scanning direction, and when there is no block position to be detected in the main scanning direction, the detection is shifted to the sub-scanning direction, then block positions are sequentially stored again in the main scanning direction. Furthermore, in storing the image data in the memory, image data of the adjoining post-correction blocks are combined and stored in the memory. The aforementioned processing is also performed with respect to the remaining blocks. The image data which has been converted and stored in the memory with respect to all block positions is outputted as the corrected image 114.

In the above-described first embodiment, for ease of explanation, the description is provided on a case where image data read by an image reading apparatus is locally distorted in the horizontal direction. However, even if the image data is locally distorted in the vertical direction, the distortion can be corrected in the similar manner to the above-described embodiment.

Furthermore, the above description has been provided on a case where the image data has no gradient and where the lengths of the facing sides of the locally distorted block are equal. However, even if the image data is tilted and the lengths of the facing sides of the distorted block are not equal, the above-described block misalignment correction processing can correct the distortion with the use of a known conversion technique, for example, affine transformation which can convert the gradient.

As has been set forth above, according to the image processing apparatus and method of the first embodiment, even if image data is locally distorted, the position of an embedded block is detected and the detected block position is corrected to an ideal value, thereby making it possible to convert the original document image data which has been read with distortion into image data having little distortion.

### Second Embodiment

Next, an image processing apparatus according to the second embodiment of the present invention is described. Note that since the configuration of the image processing apparatus is the same as that of the image processing apparatus according to the first embodiment, descriptions thereof are omitted.

In the aforementioned first embodiment, a block position in which additional information is embedded is detected. Block misalignment is detected with respect to the detected block position, and misalignment correction is performed. In accordance with the misalignment correction, the image data in the block is corrected in order to correct the distortion of the image data. However, if the image data has an area which does not include a block in which additional information is embedded, image data of the area cannot be corrected. The second embodiment is conceived by taking such situations into consideration. Hereinafter, the image reading apparatus according to the second embodiment is described.

According to the block misalignment detection method of the second embodiment, block position data 112 detected by the block position detector 102 is used to estimate a correction position of an area where no block is embedded. The block misalignment detection method according to the second embodiment is described using an example where image data obtained by the scanner 101 is locally distorted in the horizontal direction.

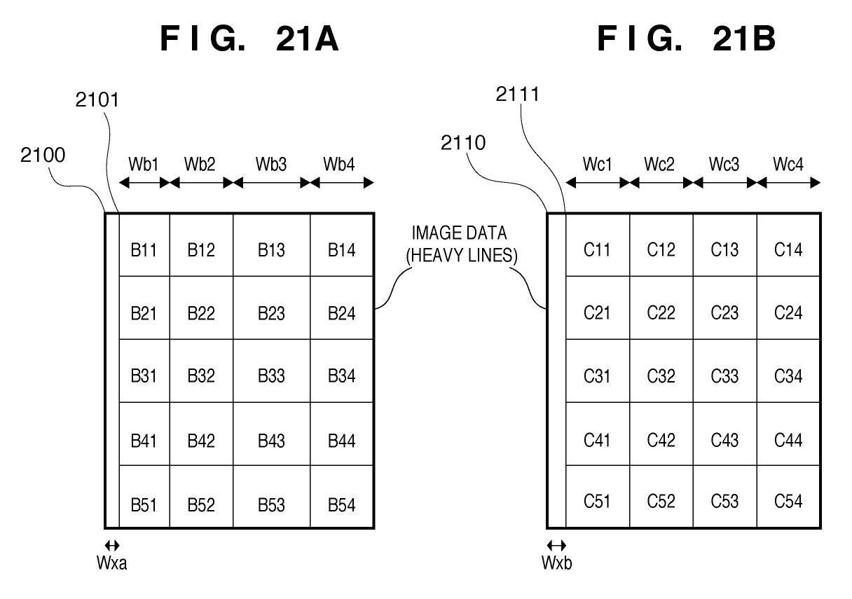

FIGS. 21A and 21B depict explanatory views showing, as an example, a relation between block positions read by the scanner 101 and ideal block positions according to the second embodiment. The drawings show an example in which a block position is located on the inner side of the read image data, and with the edge portion of the image data as a reference, there is an area where no block is embedded.

FIG. 21A shows block positions which are detected based on the image information 111 outputted by the scanner 101, while FIG. 21B shows ideal block positions. FIG. 21A corresponds to the above-described FIG. 17A. In FIG. 21A, an area having a width W×a is added to the left side of the image data. FIG. 21B corresponds to FIG. 17B. FIG. 21B includes an area having a width W×b, which is the result of correction performed on the area having the width W×a on the left side of the image data in FIG. 21A. Assume herein that the width W×a is 4 pixels. Coordinates of the vertices 2100 and 2101 are respectively (X, Y)=(0, 0) and (X, Y)=(4, 0). Since descriptions regarding Wb1 to Wb4, Wc1 to Wc4, B11 to B54, and C11 to C54 are similar to that of the above-described FIGS. 17A and 17B, descriptions thereof are omitted.

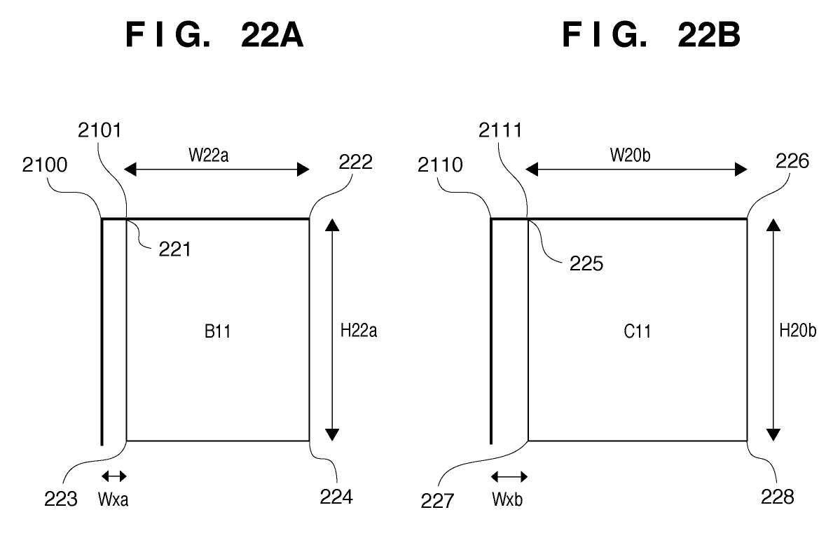

First, a block position which adjoins the area where no block is embedded is selected from the block position data 112 detected by the block position detector 102. Based on the coordinates of the four vertices of the block designated by the selected block position data 112, coordinates of the area where no block is embedded are calculated. To calculate the coordinates of the area where no block is embedded, externally dividing points of the four vertices of the adjoining block positions are calculated. The coordinates' calculation method of an area where no block is embedded is described with reference to FIGS. 22A and 22B.

FIGS. 22A and 22B depict explanatory views illustrating examples of coordinate positions of a selected block and coordinate positions of the block that has been corrected. FIG. 22A shows the selected block (B11) having four vertices 221, 222, 223, and 224. FIG. 22B shows a block (C11) obtained by correcting the block (B11), which has four vertices 225, 226, 227, and 228. FIG. 22A shows the read block of which width is narrower by 2 pixels than the actual width. Further, the coordinates of the vertices 2100, 2101, and 2110 in FIGS. 22A and 22B are the same as that of FIGS. 21A and 21B.

In calculating the coordinates of the vertex 2110 of the post-misalignment-correction block with the vertex 2100 of the pre-misalignment-correction block as a reference, coordinates of the vertex 2100 of the pre-misalignment-correction block are the same as the coordinates of the vertex 2110 of the post-correction block. Therefore, the coordinates of the vertex 2110 are (X, Y)=(0, 0). Next, to calculate coordinates of the vertex 2111 of the post-correction block based on the coordinates of the vertex 2101 of the pre-correction block, conversion information of the block information adjoining the area on the left side is used. Herein, the adjoining block is the block B11. In converting the block B11 to the block C11, the width is changed from 8 pixels to 10 pixels, that is, the block width is enlarged by five-fourth times. Based on the enlarged information, the post-correction coordinates of the area where no block is embedded are calculated. More specifically, in FIG. 22A, the width W×a of the left side area where no block is embedded is 4 pixels. The width is enlarged by five-fourth times similar to the calculated conversion information of the adjoining block, thereby obtaining the width as 5 pixels. Therefore, the width W×b is 5 pixels. As a result, the coordinates of the post-correction vertex 225 are obtained by adding 5 pixels to the coordinates of the vertex 2110, that is, (X, Y)=(5, 0).

In the foregoing manner, even if the image data includes an area where no block is embedded, the image data can be corrected by correcting the position of the area and calculating the corrected block position.

As has been set forth above, according to the second embodiment, even if the image data includes an area where no block is embedded, the size of the area is estimated based on the position information of the adjoining embedded block, and as a result, it is possible to calculate a misalignment value of the block position. Therefore, even if an area where no block is embedded is distorted in the image data, it is possible to generate image data with little distortion.

### Other Embodiments

The present invention can also be achieved in a case where a software program realizing the functions of the above-described embodiments is directly or remotely supplied to a system or an apparatus, and the supplied program is read and executed by a computer of the system or apparatus. In this case, as long as the program function is achieved, the form does not necessarily have to be a program.

Therefore, for realizing the functions according to the present invention by a computer, program codes installed in the computer also constitute the invention. In other words, claims of the present invention include the computer program itself which realizes the functions of the present invention and a computer-readable storage medium that stores the program. In this case, as long as the program function is achieved, the form of program may be of object codes, a program executed by an interpreter, script data supplied to an OS, or the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims priority from Japanese Patent Application No. 2008-114416 filed Apr. 24, 2008, which is hereby incorporated by reference herein in its entirety.

What is claimed is:

1. An image processing apparatus for reading an image and outputting image data in which distortion of the image is corrected, comprising:
an image reader configured to read an image, in which a plurality of blocks each having a feature value are embedded, and output image data of the image;
a block position detector configured to detect a position of each block, which is embedded in the image data outputted by the image reader;
a block misalignment calculator configured to calculate a misalignment value of the position of each block, which is detected by the block position detector, based on the position of the each block detected by the block position detector and a specification of the each block which has been set in advance; and
a corrector configured to correct the image data, which is outputted by the image reader, based on the misalignment value calculated by the block misalignment calculator.

2. The image processing apparatus according to claim 1, wherein the block position detector obtains a frequency feature value of the image data in block units based on the specification of the each block and a determination value which serves as a block determination reference based on the frequency feature value, and detects the position of the block based on the frequency feature value and the determination value.

3. The image processing apparatus according to claim 1, wherein the specification of the block prescribes a number of pixels included in each block, a block size, and a shape of the block.

4. The image processing apparatus according to claim 1, further comprising a designator configured to designate a detection area, which is a region of the image where a position of each block is detected by the block position detector.

5. The image processing apparatus according to claim 1, wherein the block misalignment calculator calculates, as the misalignment value, a difference between the block size prescribed by the specification and a relative position of the each block detected by the block position detector.

6. The image processing apparatus according to claim 1, wherein the corrector corrects the image data by correcting coordinates of four vertices of the each block based on the misalignment value.

7. A control method of an image processing apparatus for reading an image and outputting image data in which distortion of the image is corrected, comprising the steps of:
reading an image, in which a plurality of blocks each having a feature value are embedded, and outputting image data of the image;
detecting a position of each block, which is embedded in the image data output in the image reading step;
calculating a misalignment value of the position of each block, which is detected in the block position detecting step, based on the position of the each block detected in the block position detecting step and a specification of the each block which has been set in advance; and
correcting the image data, which is outputted in the image reading step, based on the misalignment value calculated in the block misalignment calculating step.

8. The control method according to claim 7, wherein the block position detecting step obtains a frequency feature value of the image data in block units based on the specification of the each block and a determination value which serves as a block determination reference based on the frequency feature value, and detects the position of the block based on the frequency feature value and the determination value.

9. The control method according to claim 7, wherein the specification of the block prescribes a number of pixels included in each block, a block size, and a shape of the block.

10. The control method according to claim 7, further comprising a step of designating a detection area, which is a region of the image where a position of each block is detected in the block position detecting step.

11. The control method according to claim 7, wherein the block misalignment calculating step calculates, as the misalignment value, a difference between the block size prescribed by the specification and a relative position of the each block detected in the block position detecting step.

12. The control method according to claim 7, wherein the correcting step corrects the image data by correcting coordinates of four vertices of the each block based on the misalignment value.

13. A computer-readable storage medium storing a computer program which causes a computer to execute the control method described in claim 7.
